(19) United States
(12) Patent Application Publication
(10) Pub. No.: US 2026/0118213 A1
(43) Pub. Date: Apr. 30, 2026

(54) SYSTEMS AND METHODS FOR DETERMINING FLUID FLOW ACROSS A TEST COMPONENT

(71) Applicant: General Electric Company, Evendale, OH (US)

(72) Inventors: Zachary Daniel Webster, Liberty Township, OH (US); Zachary Dean Little, Blue Ash, OH (US); Jeremy C. Bailey, Liberty Township, OH (US); Cory M. Williams, Maineville, OH (US); Kevin R. Feldmann, Mason, OH (US); Paul Hadley Vitt, Liberty Township, OH (US)

(73) Assignee: General Electric Company, Evendale, OH (US)

(21) Appl. No.: 18/925,653

(22) Filed: Oct. 24, 2024

(51) Int. Cl. G01M 9/06

(52) U.S. Cl. CPC G01M 9/067

(57) ABSTRACT

A system including a test component including a first gas channel formed in the test component, a surface at least partially coated with pressure sensitive paint, and seed channels formed in the test component extending from the first gas channel to the surface, the seed channels defining seed holes formed in the surface opposite the first gas channel. A first gas source delivers a first gas to the first gas channel, a second gas source delivers a second gas across the seed holes, an imaging device capturing image data of a seed flow streak of the first gas based on a change in luminescence intensity of the pressure sensitive paint, and an electronic control unit determines whether an angle between the seed flow streak and an imaginary line extending parallel to a centerline of the test component is greater than a predetermined threshold.

### TECHNICAL FIELD

The present specification generally relates to systems and methods for detecting fluid flow across a surface of a test component and, more specifically, systems and methods for determining whether parameters of a test component should be adjusted based on the detected fluid flow.

### BACKGROUND

In the field of aerodynamics, accurately detecting and analyzing fluid flow over aircraft components is crucial for optimizing performance, efficiency, and safety. Wind tunnel testing is a widely used method for simulating real-world aerodynamic conditions and evaluating the behavior of air as it flows over various parts of an aircraft. Current solutions for detecting fluid flow within wind tunnel tests primarily include pressure sensors, flow visualization techniques, and particle image velocimetry (PIV). Pressure sensors measure the pressure distribution on the surface of the aircraft component, providing quantitative data on lift, drag, and other aerodynamic forces. Flow visualization techniques, such as smoke trails and dye injection, offer qualitative insights into flow patterns, turbulence, and vortex formation. PIV, an advanced optical method, uses tracer particles and high-speed cameras to capture airflow movement and calculate velocity fields. Such flow visualization techniques are also utilized in the automotive field and environmental studies.

Despite advancements in these methods, challenges remain in achieving high-resolution, real-time flow detection with minimal disruption to the airflow itself. Pressure sensors require extensive calibration, flow visualization methods often lack precision, and PIV is an expensive and complex technique requiring sophisticated equipment and significant post-processing. These challenges highlight the need for innovative approaches to enhance the detection and analysis of fluid flow over components in wind tunnel tests, balancing accuracy, cost, and ease of use.

Accordingly, a need exists for improved systems and methods for testing and forming a component for optimizing fluid flow across a surface of the component.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a system including a test component, according to one or more embodiments shown and described herein;

FIG. 2 schematically depicts a partial cross-sectional view of the test component, according to one or more embodiments shown and described herein;

FIG. 3 schematically depicts another partial cross-sectional view of the test component, according to one or more embodiments shown and described herein;

FIG. 4 schematically depicts a partial cross-sectional view of another embodiment of a test component, according to one or more embodiments shown and described herein;

FIG. 5 schematically depicts a plan view of the test component of FIG. 3, according to one or more embodiments shown and described herein;

FIG. 6 schematically depicts components of the system other than the test component, according to one or more embodiments shown and described herein;

FIG. 7 schematically depicts a flowchart of a method for detecting fluid flow across a surface of the test component, according to one or more embodiments shown and described herein; and

FIG. 8 schematically depicts a flowchart of a method for determining whether a streak condition of fluid flow across a surface of the test component is satisfied, according to one or more embodiments shown and described herein.

### DETAILED DESCRIPTION

Embodiments described herein are directed to systems for detecting fluid flow across a surface of a test component and methods of operation.

The system includes a test component including a first gas channel formed in the test component, a surface at least partially coated with pressure sensitive paint, and seed channels formed in the test component extending from the first gas channel to the surface, the seed channels defining seed holes formed in the surface opposite the first gas channel. A first gas source delivers a first gas to the first gas channel, a second gas source delivers a second gas across the seed holes, an imaging device capturing image data of a seed flow streak of the first gas based on a change in luminescence intensity of the pressure sensitive paint, and an electronic control unit determines whether an angle between the seed flow streak and an imaginary line extending parallel to a centerline of the test component is greater than a predetermined threshold.

By detecting the degree of deviation of the seed flow stream relative to the imaginary line, it is possible to determine that changes to either the test component itself or operating parameters need to be made to optimize the flow of fluid across the surface of the test component. Specifically, changes to one or more parameters may be made to the test component to ensure that the deviation does not exceed a predetermined threshold. The test component itself and/or adjustments to the flow of gas to the test component may be adjusted and the test repeatedly preformed to confirm that any deviation of the seed flow stream falls within acceptable parameters. Upon confirmation that the seed flow stream satisfies this condition, a final component may be formed.

Various embodiments of the system and methods of operation of the system are described in more detail herein. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

It is noted that the term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

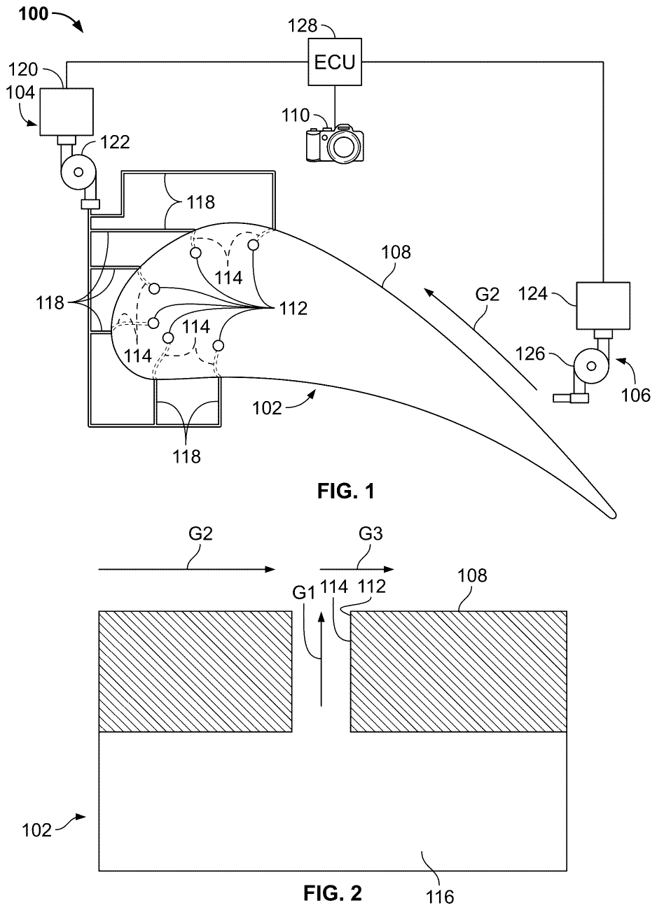

Referring now to FIG. 1, a system 100 for detecting fluid flow across a surface of a test component is illustrated according to one or more embodiments described herein. The system 100 may generally include a test component 102, a first gas source 104 for directing a first gas through an interior cavity of the test component 102, a second gas source 106 for directing a second gas across a surface 108 of the test component 102, and an imaging device 110 for detecting a streamline or flow direction of the first gas across the surface 108 of the test component 102 once the first gas exits the interior cavity. As described herein, the surface 108 may refer to an exterior surface 108 of the test component 102. However, it should be appreciated that the surface 108 may be any surface other than an exterior surface, for example, an interior surface within the test component 102, which remains at least partially optically accessible by the imaging device 110 to detect a flow direction of the first gas across the surface 108. In instances in which the surface 108 is an interior surface, the interior surface may be formed as a channel or passageway within the test component 102.

As shown in FIG. 1, the test component 102 is depicted as an air foil for a turbine engine. However, it should be appreciated that the test component 102 illustrated and described herein is merely one example of such a test component. Accordingly, other test components are contemplated herein and the present disclosure should not be limited as such. For example, other non-limiting examples of test components could be, for example, fan blades, compressor blades, guide vanes, stator vanes, and the like. Additionally, other test components may include components utilized in other fields, for example, automotive, environmental, construction, electrical, and the like. As referred to herein, the term “test component” merely refers to a component that is used to test certain operating parameters prior to finalizing the component for mass production. However, it should be appreciated that the concept disclosed herein may be equally applicable to components that are already in mass production. As such, a test component may be structurally identical to a component intended for mass production or a product of mass production.

As described herein, the test component 102 is utilized to determine a streamline or flow direction of gas over particular areas of the test component 102. Pressure sensitive paint (PSP) is a useful tool for visualizing and measuring aerodynamic phenomena, including the identification of flow direction of a gas. Accordingly, the exterior surface 108 of the test component 102 is at least partially coated with PSP, which contains luminescent molecules that are sensitive to oxygen. The exterior surface 108 of the test component 102 may be illuminated with an excitation light source, usually in the ultraviolet (UV) or blue spectrum. This causes the luminescent molecules in the PSP to fluoresce. The luminescence of the PSP is inversely proportional to a partial pressure of oxygen. Accordingly, as the first gas flows over the exterior surface 108 of the test component 102, pressure variations cause changes in the luminescence intensity of the PSP.

The test component 102 includes one or more seed holes 112 formed in the exterior surface 108 of the test component 102. As shown in FIG. 1, a plurality of seed holes 112 are formed at the exterior surface 108 of the test component 102. As described in more detail herein, the seed holes 112 are formed at an end of a seed channel 114 at least partially defined by a wall thickness of the test component 102. The seed channels 114 each extend substantially perpendicular to a curvature of the exterior surface 108 of the test component 102 at the associated seed hole 112. As used herein, the term seed hole refers to a small hole terminating at an end of a seed channel used during the initial stages of drilling or machining. A seed hole also refers to a small opening or orifice used to introduce air or other gases into a seed channel and provide precise airflow control.

The number, location, and size of the seed holes 112 are not limited to that depicted herein. For example, any number of seed holes 112 may be formed within exterior surface 108 of the test component 102 at any suitable location. For example, a plurality of seed holes 112 may be formed at a particular location of the test component 102 to determine performance of the test component 102 at that particular location and whether modifications to the test component 102 itself or one or more other operating parameters need to be made based on data collected during testing, as described in more detail herein. In embodiments, the seed holes 112 may have a circular shape or non-circular shape, for example, elliptical. Additionally, the seed holes 112 may be equidistantly spaced apart from one another or arranged in any suitable manner based on the curvature of the test component 102 and particular location of the test component 102 that data is desired to be collected.

Additionally, the seed holes 112 may have any suitable size. For example, a diameter of the seed holes 112 may be between 0.1 mm and 10 mm. In embodiments, the diameter of the seed holes 112 is less than 2 mm. In embodiments, the diameter of the seed holes 112 is between 0.1 mm and 0.5 mm. In embodiments, the diameter of the seed holes 112 is between 0.1 mm and 1 mm. In embodiments, the diameter of the seed holes 112 is between 0.1 mm and 2 mm. In embodiments, the diameter of the seed holes 112 is less than 1 mm. In embodiments, the diameter of the seed holes 112 is less than 0.5 mm. Further, in embodiments, the diameter of each seed hole may be the same. In other embodiments, the diameter of each seed hole 112 or a subset of the seed holes 112 may differ.

A first gas channel 116 extends between a respective seed channel 114 and a perimeter of the test component 102. As shown in FIG. 1, a plurality of first gas channels 116 are formed within the test component 102, with each first gas channel 116 being associated with a respective seed channel 114 and a respective seed hole 112. However, as described in embodiments herein, a single first gas channel 116 may be formed within the test component 102 and the one or more seed channels 114 may extend directly from the first gas channel 116 to respective seed holes 112.

It should be appreciated that the seed holes 112, the seed channels 114, and the first gas channels 116 may be formed within the test component 102 in any suitable manner. For example, the seed holes 112, the seed channels 114, and the first gas channels 116 may be formed may be formed by drilling bores into an already manufactured test component such that tests may be performed on the test component 102 to determine what modifications, if any, need to be made to improve performance of the test component 102. In other embodiments, the seed holes 112, the seed channels 114, and the first gas channels 116 may be formed during the initial manufacturing of the test component 102, for example, during an additive manufacturing process to form the test component 102.

The first gas source 104 includes one or more first gas lines 118 extending to the test component 102 corresponding to the number of first gas channels 116 thereby placing the first gas source 104 in fluid communication with each of the one or more seed channels 114. In the embodiment illustrated in FIG. 1 in which the test component 102 includes a plurality of first gas channels 116 each associated with a respective seed hole 112, the first gas source 104 includes a plurality of first gas lines 118. However, in other embodiments in which only a single first gas channel 116 is formed in the test component 102, as described in more detail herein, the first gas source 104 may include only a single first gas line 118 extending to the first gas channel 116. The first gas source 104 may include a first gas storage unit 120 and a first gas pump 122 for directing first gas stored within the first gas storage unit 120 into the seed channels 114 formed in the test component 102. Accordingly, when the first gas pump 122 is activated, the first gas from the first gas storage unit 120 is distributed to each of the seed holes 112. In embodiments, the first gas stored within the first gas storage unit 120 to be delivered to the test component 102 is a non-oxygenated species, for example, N₂, CO₂, Argon, and the like.

Similar to the first gas source 104, the second gas source 106 includes a second gas storage unit 124 and a second gas pump 126 for directing second gas stored within the second gas storage unit 124 across the exterior surface 108 of the test component 102 and across the seed holes 112. Accordingly, when the second gas pump 126 is activated, the second gas from the second gas storage unit 124 is directed to flow across the exterior surface 108 of the test component 102 in the direction of arrow G2 across each of the seed holes 112. In embodiments, the second gas stored within the second gas storage unit 124 to be is an oxygenated species, for example, O₂, CO, and the like.

As described in more detail herein, the second gas being directed over the exterior surface 108 of the test component 102 may cause a flow direction of the first gas exiting the seed holes 112 to deviate from an imaginary line. As described herein, the imaginary line runs parallel to a centerline of the test component 102. Data pertaining to the degree of deviation from the imaginary line is collected, for example, by the imaging device 110, and utilized to determine whether one or more modifications to parameters of the test component 102 should be made.

The imaging device 110 may be any suitable image capture device for collecting image data pertaining to the test component 102. As noted herein, the exterior surface 108 of the test component 102 is coated with PSP such that the flow direction of the first gas may be visibly detected by the imaging device 110. Specifically, the imaging device 110 captures the light emitted by the PSP on the exterior surface 108 of the test component 102. The imaging device 110 may include a photodetector, a lens system that focuses incoming light onto the photodetector, such as a CCD (charge-coupled device), a CMOS sensor, or the like. The photodetector converts light photons into electrical signals by measuring the intensity of light at each pixel location. These signals are then processed to form a digital image. The imaging device 110 may additionally include components like filters, image processors, and storage systems to enhance image quality and manage data. The imaging device 110 may be, for example, a CMOS camera, a CCD camera, a high-speed digital camera, a PSP imaging system, or the like. Image data may be captured by the imaging device 110 before and during the flow of the first gas and the second gas to provide a reference image data and a test image data, respectively.

An electronic control unit 128, described in more detail herein, is communicatively coupled with the first gas source 104 and the second gas source 106. Accordingly, the electronic control unit 128 controls operation of the first gas source 104 and the second gas source 106, for example, the rate at which the first gas source 104 and the second gas source 106 direct respective gas to the test component 102. The electronic control unit 128 is also communicatively coupled to the imaging device 110 so as to control image capture operations of the imaging device 110 and to receive image data from the imaging device 110 after images are captured. As described in more detail herein, the images captured by the imaging device 110 are processed and analyzed to determine pressure distribution across the exterior surface 108 of the test component 102. By comparing the luminescence intensity variations, pressure maps may be created. In some embodiments, small particles or dye may be added to the first gas and the interaction of these particles or dye with the PSP may help visualize streak lines, indicating flow direction of the first gas.

Referring now to FIG. 2, an enlarged partial cross-section of the test component 102 is illustrated depicting a single seed hole 112 formed at the exterior surface 108 of the test component 102. The seed hole 112 is provided at an end of the seed channel 114, which extends from the first gas channel 116 formed through the test component 102. The seed channel 114 extends substantially perpendicular to the particular location at which the seed hole 112 is formed in the exterior surface of the test component 102. In embodiments, the seed channel 114 extends 90 degrees+/−5 degrees (85 degrees to 95 degrees) relative to the exterior surface 108 to the particular location at which the seed hole 112 is formed in the exterior surface 108 of the test component 102. In embodiments, the seed channel 114 extends 90 degrees+/−10 degrees (80 degrees to 100 degrees) to the particular location at which the seed hole 112 is formed in the exterior surface 108 of the test component 102. In embodiments, the seed channel 114 extends 90 degrees+/−15 degrees (75 degrees to 105 degrees) to the particular location at which the seed hole 112 is formed in the exterior surface 108 of the test component 102. In embodiments, the seed channel 114 extends 90 degrees+/−20 degrees (70 degrees to 110 degrees) to the particular location at which the seed hole 112 is formed in the exterior surface 108 of the test component 102. It should be appreciated that the first gas channel 116 may extend along any path, for example, a serpentine flow path, as the curvature of first gas channel 116 does not directly impact the flow of the first gas exiting the seed hole 112 due to the seed channel 114 extending substantially perpendicular to the exterior surface 108 of the test component 102. However, in embodiments, as shown, the first gas channel 116 extends substantially parallel to the exterior surface 108 of the test component 102 and in a linear direction.

As described herein, a plurality of seed channels 114 may extend from a single first gas channel 116 by the first gas source 104 (FIG. 1) and into the seed channel 114 toward the seed hole 112, as depicted by arrow G1 representing a first gas flow path. Simultaneously, the second gas is directed across the exterior surface 108 of the test component 102 by the second gas source 106 (FIG. 1) to pass over the seed hole 112, as depicted by arrow G2 representing a second gas flow path. As the first gas exits the seed hole 112, the first gas is met by the second gas, as depicted by arrow G3 representing a deviated second gas flow path. As described herein, a degree of deviation of the flow direction of the first gas relative to an imaginary line is detected.

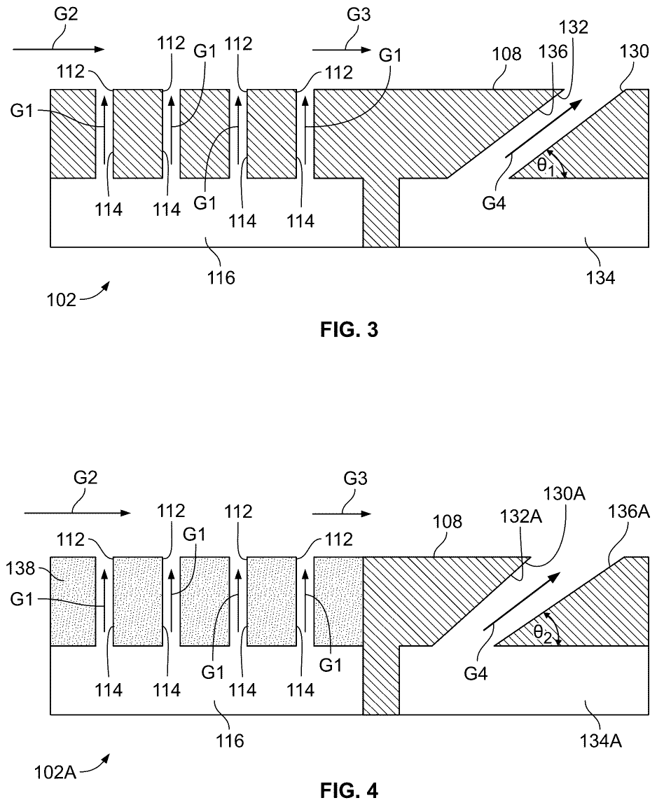

Referring now to FIG. 3, an enlarged partial cross-section of the test component 102 is illustrated depicting a plurality of seed holes 112 formed at the exterior surface 108 of the test component 102. Each seed hole 112 is provided at an end of a respective seed channel 114 extending from the first gas channel 116 formed in the test component 102. Accordingly, the first gas may be delivered to the first gas channel 116 by the first gas source 104 (FIG. 1) and evenly distributed through each of the seed channels 114 and out of the respective seed holes 112. The flow of the first gas through each of the seed channels 114 is depicted by arrows G1. As described herein, the second gas is directed over the exterior surface 108 of the test component 102 by the second gas source 106 (FIG. 1) and, specifically, across each of the seed holes 112.

In embodiments, one or more cooling holes 130 may be formed in the exterior surface 108 of the test component 102. As shown in FIG. 3, a single cooling hole 130 is formed in the exterior surface 108 of the test component 102 downstream of the seed holes 112. The cooling hole 130 is provided at an end of a cooling channel 132. Accordingly, cooling gas, such as air or the like, is directed through the cooling channel 132 and out through the cooling hole 130 to the exterior surface 108 of the test component 102 in the direction of arrow G4 representing a cooling gas flow path.

In embodiments, the cooling channel 132 includes a first cooling channel section 134 and a second cooling channel section 136. The first cooling channel section 134 extends from a cooling gas source such that cooling gas may be delivered to the cooling holes 130. In embodiments, the first cooling channel section 134 extends substantially parallel to the first gas channel 116. However, it should be appreciated that the first cooling channel section 134 may extend along any path, for example, a serpentine flow path. The second cooling channel section 136 extends from the first cooling channel section 134 to the exterior surface 108 of the test component 102 in a direction downstream of the flow of the second gas. In embodiments, the second cooling channel section 136 has a constant diameter. An upstream side of the second cooling channel section 136 intersects a particular location of the exterior surface 108 where the cooling hole 130 is formed at a cooling angle θ₁. In embodiments, the cooling angle θ₁ is 45 degrees +/−5 degrees (40 degrees to 50 degrees) relative to the exterior surface 108. In embodiments, the cooling angle θ₁ is 45 degrees+/−10 degrees (35 degrees to 55 degrees). In embodiments, the cooling angle θ₁ is 45 degrees+/−15 degrees (30 degrees to 60 degrees). In embodiments, the cooling angle θ₁ is 45 degrees+/−20 degrees (25 degrees to 65 degrees). In embodiments, the cooling angle θ₁ is 45 degrees+/−25 degrees (20 degrees to 70 degrees). In embodiments, the cooling angle θ₁ is 45 degrees+/−30 degrees (15 degrees to 75 degrees). Accordingly, the second cooling channel section 136 intersects the exterior surface 108 of the test component 102 at an angle less than the angle at which the seed channel 114 intersects the exterior surface 108 of the test component 102.

Referring now to FIG. 4, another embodiment of a test component 102A is depicted. It should be appreciated that the test component 102A is substantially similar to the test component 102 described herein and illustrated in FIG. 3. Therefore, like reference numbers will be used to refer to like parts. Specifically, the test component 102A includes a plurality of seed holes 112 and one or more cooling holes 130. However, the test component 102A differs from the test component 102 illustrated in FIG. 3 in that the test component 102A illustrated in FIG. 4 includes a porous material 138 provided in the particular area of the test component 102A to which a flow of the first gas is directed. Accordingly, the first gas is permitted to flow through the porous material 138, as shown by arrows G1.

In embodiments, the porous material 138 includes a sponge. As such, the first material is directed to flow through pores in the porous material 138 in the direction of arrows G1. The seed holes 112 are formed at an upper surface of the porous material 138 opposite the first gas channel 116 and a plurality of seed channels 114 may be formed within the porous material 138 extending between the first gas channel 116 and the seed holes 112.

As discussed herein with respect to the test component 102 illustrated in FIG. 3, the first gas exits the seed holes 112 and interacts with the second gas directed to flow across the seed holes 112, as depicted by arrows G2, resulting in a flow path depicted by arrow G3. As described herein, the flow of the second gas may result in a deviation of the flow of the first gas from an imaginary line across the exterior surface 108 of the test component 102.

Additionally, as described above with respect to the test component 102 depicted in FIG. 3, the test component 102A may include one or more cooling holes 130A formed in the exterior surface 108 of the test component 102A. As shown in FIG. 4, a single cooling hole 130A is formed in the exterior surface 108 of the test component 102A downstream of the seed holes 112. The cooling hole 130A is provided at an end of a cooling channel 132A. Accordingly, cooling gas, such as air or the like, is directed through the cooling channel 132 and out through the cooling hole 130 to the exterior surface 108 of the test component 102A in the direction of arrow G4.

In embodiments, the cooling channel 132A includes a first cooling channel section 134A, similar to the first cooling channel section 134 depicted in FIG. 3, and a second cooling channel section 136A, similar to the second cooling channel section 136 depicted in FIG. 3. The first cooling channel section 134A extends from a cooling gas source such that cooling gas may be delivered to the cooling holes 130A. In embodiments, the first cooling channel section 134A extends substantially parallel to the first gas channel 116. However, it should be appreciated that the first cooling channel section 134A may extend along any path, for example, a serpentine flow path. The second cooling channel section 136A extends from the first cooling channel section 134A to the exterior surface 108 of the test component 102A in a direction downstream of the flow of the second gas. Contrary to the second cooling channel section 136 depicted in FIG. 3, in embodiments, the second cooling channel section 136A has a diameter that increases from the first cooling channel section 134A to the cooling hole 130A. Accordingly, a diameter of the cooling hole 130A at the exterior surface 108 is greater than a diameter of the second cooling channel section 136A at the first cooling channel section 134A. An upstream side of the second cooling channel section 136A intersects a particular location of the exterior surface 108 where the cooling hole 130A is formed at a cooling angle θ₂. In embodiments, the cooling angle θ₂ is 35 degrees+/−5 degrees (30 degrees to 40 degrees) relative to the exterior surface 108. In embodiments, the cooling angle θ₂ is 35 degrees+/−10 degrees (25 degrees to 45 degrees). In embodiments, the cooling angle θ₂ is 35 degrees+/−15 degrees (20 degrees to 50 degrees). In embodiments, the cooling angle θ₂ is 35 degrees+/−20 degrees (15 degrees to 55 degrees). In embodiments, the cooling angle θ₂ is 35 degrees+/−25 degrees (10 degrees to 60 degrees). In embodiments, the cooling angle θ₂ is 35 degrees+/−30 degrees (5 degrees to 65 degrees). Accordingly, the second cooling channel section 136A intersects the exterior surface 108 of the test component 102A at an angle less than the angle at which the seed channel 114 intersects the exterior surface 108 of the test component 102.

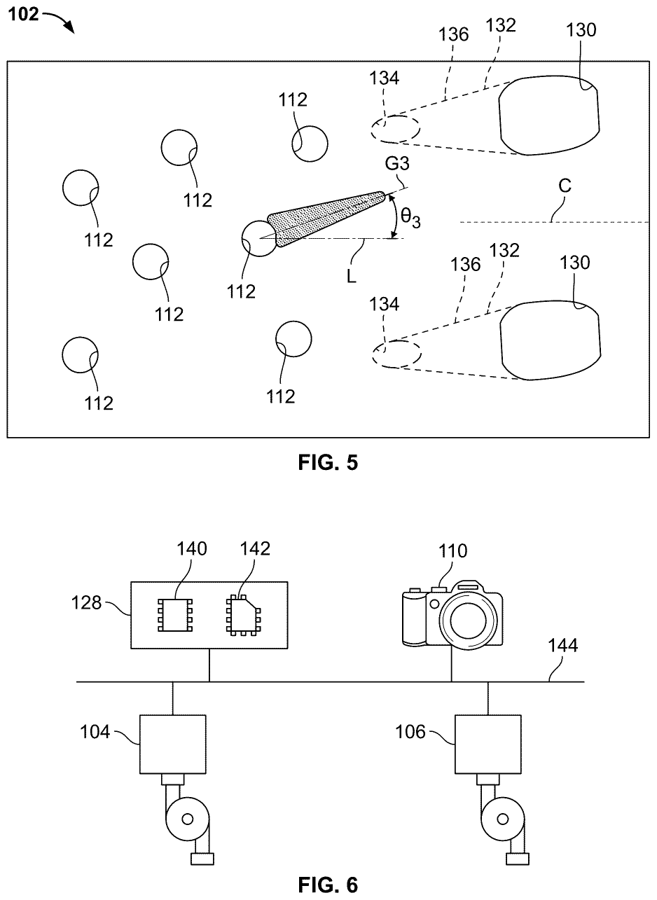

Referring now to FIG. 5, a plan view of the test component 102 of FIGS. 1-3 is depicted illustrating a plurality of seed holes 112 and a plurality of cooling holes 130. However, as described herein, embodiments are contemplated in which only a single seed hole 112 is provided. Additionally, embodiments are contemplated in which a single cooling hole 130 is provided or, alternatively, no cooling holes 130 are provided. As shown, the seed holes 112 are positioned rearward or upstream of the cooling holes 130 relative to the direction which the second gas is passing across the exterior surface 108 of the test component 102. However, in other embodiments, the seed holes 112 may be provided forward or downstream of the cooling holes 130. Further, as shown, the seed holes 112 are also positioned between the pair of cooling holes 130 in a width direction of the test component 102. However, in other embodiments, the seed holes 112 may be located outside of a space defined between the cooling holes 130 such that one or more of the cooling holes 130 are located between any of the seed holes 112.

As shown in FIG. 5, a flow path of the first gas exiting one of the seed holes 112 is illustrated by a shaded region extending from the seed hole 112. As noted above, the exterior surface 108, or at least a portion of the exterior surface 108 at which the seed holes 112 are formed, of the test component 102 is coated with PSP. Accordingly, a streamline or flow direction of the first gas is detectable by the changes in the luminescence intensity on the PSP caused by the first gas.

As described herein, the flow of the second gas intersecting with the first gas exiting the seed holes 112 may cause the flow path of the first gas to deviate from an imaginary line running parallel to a centerline of the test component. Specifically, a centerline of the test component 102 is depicted by line C. In embodiments, the centerline C of the test component 102 refers to an imaginary line that runs through a geometric center of the test component 102 following an axis of symmetry. The centerline C serves as a reference for positioning, alignment, and/or dimensional measurements. The centerline C is used to ensure balance, streamline airflow, and/or indicate an optimal orientation of the test component 102 relative to an overall design of an aircraft, automotive, or other assembly to which it is attached. For example, in a cylindrical aerospace component, the centerline C typically runs along a longitudinal axis, where the component's mass and structural forces are evenly distributed around. As shown, the first gas exiting one of the seed holes 112 has a flow path G3. Due to flow path of the second gas interfering the flow path of the first gas, the flow path of the first gas deviates from an imaginary line L extending from the respective seed hole 112 parallel to the centerline C by a degree of deviation θ₃. The degree of deviation θ₃ of the flow path of the first gas exiting each of the seed holes 112 may be detected based on the changes in the luminescence intensity on the PSP. Specifically, the luminescence may be detected by the imaging device 110 (FIG. 1).

In embodiments, the electronic control unit 128 (FIG. 1), described here, is configured to collect image data from the imaging device 110 (FIG. 1) to determine whether the degree of deviation θ₃ exceeds a predetermined threshold. If so, action may be taken to account for the excessive deviation. In embodiments, the same process may be utilized to detect a degree of deviation of the cooling gas exiting the cooling holes 130 relative to an imaginary line extending from the respective seed hole parallel to the centerline C. Based on whether the degree of deviation of the cooling gas exiting the cooling holes 130 exceeds a predetermined threshold, action may be taken to account for this excessive deviation as well. In embodiments, the predetermined threshold is selected and stored within the electronic control unit 128 (FIG. 1) in advance of performing the above steps. The predetermined threshold may be set as a distinct value or a range of values. Additionally, the predetermined threshold may include a variance at an upper range and a lower range.

Referring now to FIG. 6, depicts a schematic diagram of the electronic control unit 128 communicatively coupled to the imaging device 110, the first gas source 104, and the second gas source 106. The electronic control unit 128 includes one or more processors 140 and one or more memory modules 142. Each of the one or more processors 140 may be any device capable of executing machine readable and executable instructions. Accordingly, each of the one or more processors 140 may be an integrated circuit, a microchip, a computer, or any other computing device. The one or more processors 140 are coupled to a communication path 144 that provides signal interconnectivity between various modules of the electronic control unit 128. Additionally, the communication path 144 communicatively couples the electronic control unit 128 to the imaging device 110, the first gas source 104, and the second gas source 106. Accordingly, the communication path 144 may communicatively couple any number of processors 140 with one another, and allow the modules coupled to the communication path 144 to operate in a distributed computing environment. Specifically, each of the modules may operate as a node that may send and/or receive data. As used herein, the term “communicatively coupled” means that coupled components are capable of exchanging data signals with one another, for example, electrical signals via conductive medium, electromagnetic signals via air, optical signals via optical waveguides, and the like.

Accordingly, the communication path 144 may be formed from any medium that is capable of transmitting a signal, for example, conductive wires, conductive traces, optical waveguides, or the like. In some embodiments, the communication path 144 may facilitate the transmission of wireless signals, such as WiFi, Bluetooth®, Near Field Communication (NFC) and the like. Moreover, the communication path 144 may be formed from a combination of mediums capable of transmitting signals. In one embodiment, the communication path 144 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

As noted above, the electronic control unit 128 includes one or more memory modules 142 coupled to the communication path 144. The one or more memory modules 142 may comprise RAM, ROM, flash memories, hard drives, or any device capable of storing machine readable and executable instructions such that the machine readable and executable instructions can be accessed by the one or more processors 140. The machine readable and executable instructions may comprise logic or algorithm(s) written in any programming language of any generation (e.g., 1GL, 2GL, 3GL, 4GL, or 5GL), for example, machine language that may be directly executed by the processor, or assembly language, object-oriented programming (OOP), scripting languages, microcode, etc., that may be compiled or assembled into machine readable and executable instructions and stored on the one or more memory modules 142. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

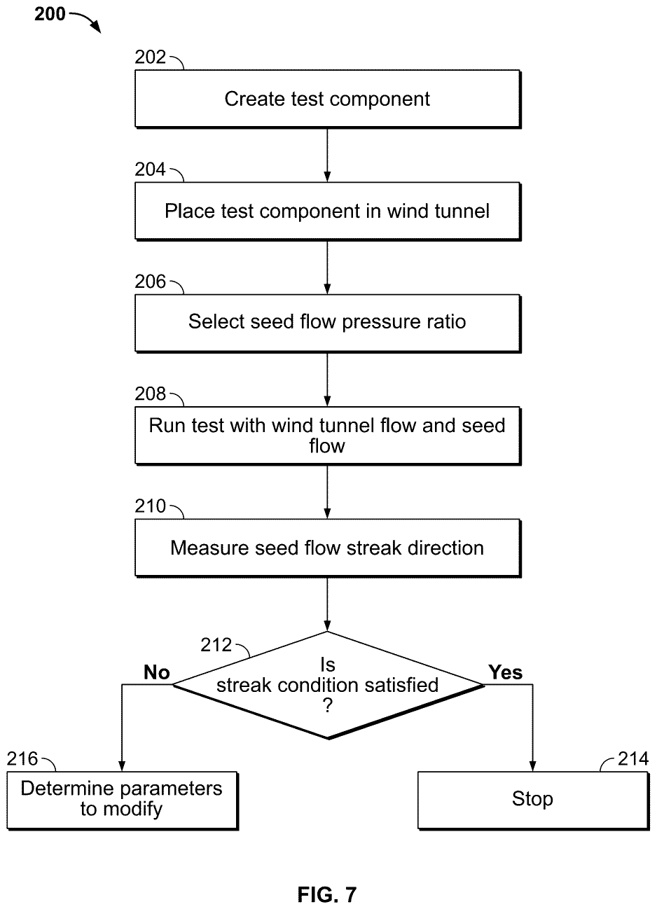

Referring now to FIG. 7, a method 200 is depicted for testing operating parameters of a test component for purposes of determining manufacturing criteria for a final component based on the test component, according to one or more embodiments shown and described herein. The method 200 is described herein with reference to FIGS. 1-3, 5, and 6.

At step 202, a test component, for example, the test component 102, is created. The test component 102 may be created or formed in any suitable manner, for example, additive manufacturing, sheet metal forming, injection molding, and the like. Either during or subsequent to manufacturing of a body of the test component 102, the first gas channel 116 is formed within an interior of the test component 102. One or more seed channels 114 extend from the first gas channel 116 through a wall of the test component 102 and terminates at the exterior surface 108 of the test component 102 forming respective seed holes 112. As described herein, the first gas channel 116 may be formed within the test component 102 to extend along any path or orientation. However, the seed channels 114 extend substantially perpendicular to the exterior surface 108 of the test component 102. The seed channels 114 and associated seed holes 112 may be formed at any location and in any arrangement along the test component 102. However, it is appreciated that the seed holes 112 are formed at a particular location of the test component 102 for which performance testing is desired. In some embodiments, as discussed herein, one or more cooling channels 132 and associated cooling holes 130 may also be formed in the test component 102.

In embodiments in which the first gas channel 116, the seed channels 114, the seed holes 112, the cooling channels 132, and the cooling holes 130, are formed after the body of the test component 102 is formed, the first gas channel 116, the seed channels 114, the seed holes 112, the cooling channels 132, and the cooling holes 130 may be formed by drilling or the like. Either before or after the first gas channel 116, the seed channels 114, the seed holes 112, the cooling channels 132, and the cooling holes 130 are formed in the test component 102, the exterior surface 108 of the test component 102 is coated with PSP.

At step 204, the test component 102 is placed in a wind tunnel. Specifically, the wind tunnel may include a test section in which the test component 102 is placed, and a drive system in which the second gas source 106 is located and operated to direct the second gas across the exterior surface 108 of the test component 102. The imaging device 110 is positioned within the test section to determine flow visualization of the first gas across the exterior surface 108 of the test component 102 effected by the flow of the second gas, as described herein.

It should be understood that there is a particular pressure ratio range between the pressure of the second gas flowing over the exterior surface 108 of the test component 102 and the pressure of the first gas flowing out of the seed holes 112 that should be utilized to provide optimal impact on the PSP coating of the test component 102. Therefore, prior to triggering the first gas source 104 and the second gas source 106 and running the tests, a seed flow pressure ratio is determined at step 206. The seed flow pressure ratio is a ratio of the first gas flowing out of the seed holes 112 relative to the second gas flowing over the exterior surface 108 of the test component 102. Specifically, in operation, the pressure of the first gas is greater than the pressure of the second gas. In embodiments, the seed flow pressure ratio is greater than or equal to 1.01 and less than or equal to 1.2. In embodiments, the seed flow pressure ratio is greater than 1.02 and less than 1.1. In embodiments, the seed flow pressure ratio is 1.05+/−5%. It should be appreciated that if the pressure of the first gas is too high relative to the pressure of the second gas, the first gas will exit the seed holes 112 with such force that the second gas may not have a significant impact on the flow direction of the first gas and the first gas will not have an effect on the PSP. Alternatively, if the pressure of the first gas is too low relative to the pressure of the second gas, the first gas will not have enough force to overcome the force of the second gas and exit the seed holes 112 and, thus, will similarly not have an effect on the PSP.

In order to determine the particular seed flow pressure ratio, the pressure of the first gas and the pressure of the second gas may be adjusted by the electronic control unit 128 controlling operation of the first gas source 104 and the second gas source 106. Specifically, the electronic control unit 128 may be controlled to operate the first gas source 104 to select a particular pressure for the first gas. Thereafter, the electronic control unit 128 may be controlled to operate the second gas source 106 to select an appropriate pressure for the second gas that satisfies the seed flow pressure ratio. Alternatively, the electronic control unit 128 may be controlled to operate the second gas source 106 to select a particular pressure for the second gas. Thereafter, the electronic control unit 128 may be controlled to operate the first gas source 104 to select an appropriate pressure for the first gas that satisfies the seed flow pressure ratio.

At step 208, a test is run by triggering the first gas source 104 and the second gas source 106, as instructed by the electronic control unit 128. Specifically, the first gas source 104 directs the first gas through the first gas channel 116 and out of the one or more seed holes 112 through the associated seed channels 114. Additionally, the second gas source 106 directs the second gas into the test section of the wind tunnel and across the exterior surface 108 of the test component 102 over the one or more seed holes 112. As described herein, the cooling gas source may also be operated in response to receiving instruction from the electronic control unit 128.

As described herein, the flow of the second gas causes the flow path of the first gas to deviate from the imaginary line L extending parallel to the centerline C of the test component 102 as the first gas exits the respective seed holes 112. At step 210, the imaging device 110 captures image data relating to the visible increase in the fluorescence on the PSP caused by the flow of the first gas across the exterior surface 108 of the test component 102. Specifically, the image data captured by the imaging device 110 is transmitted to the electronic control unit 128 that processes the image data to identify a seed flow streak or path of the first gas upon exiting the seed holes 112. In addition, the electronic control unit 128 determines the degree of deviation of the flow path of the first gas relative to the imaginary line L extending parallel to the centerline C of the test component 102. The imaging device 110 may collect similar image data for each flow path of the first gas exiting each seed hole 112. Accordingly, the electronic control unit 128 may determine a degree of deviation for each flow path of the first gas at each seed hole relative to a respective imaginary line extending parallel to the centerline C of the test component 102.

At step 212, the electronic control unit 128 determines, after a predetermined time of triggering the first gas source 104 and the second gas source 106 and performing the test, if the deviation is equal to or less than the predetermined threshold such that a streak condition is satisfied. If so, the method 200 proceeds to step 214 at which electronic control unit ceases operation of the first gas source 104 and the second gas source 106, and the test is stopped. Alternatively, if the deviation exceeds the predetermined threshold, the method 200 proceeds to step 216 at which point the electronic control unit 128 determines what action may be taken to account for these excessive deviations.

Based on the degree of deviation of the first gas exiting the seed holes 112 relative to the imaginary line L, the electronic control unit 128 may determine one or more parameters may be modified. These parameters may include, for example, adjusting a curvature of the exterior surface 108 of the test component 102 at the seed holes 112, adding a screen filter to a gas source and/or adjusting a flow of gas over the test component 102, and/or adjusting the arrangement of the cooling holes 130 by changing a location, shape, and/or size of the cooling holes 130. Upon determining the one or more parameters to be adjusted, the electronic control unit 128 may provide instructions, such as via a visual display or other manner, how to carry out such modifications and to what extent. Modified test components may be formed and tests repeated to confirm that the degree of deviation no longer exceeds the predetermined threshold prior to finalizing the design for the final component.

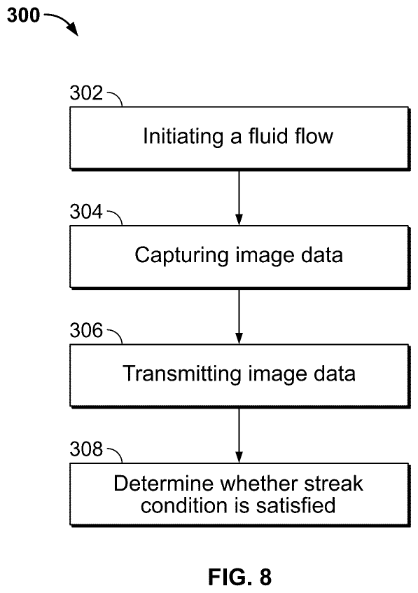

Referring now to FIG. 8, a method 300 is depicted for testing operating parameters of a test component for purposes of determining manufacturing criteria for a final component based on the test component, according to one or more embodiments shown and described herein. The method 300 is described herein with reference to FIGS. 1-3, 5, and 6. It should be appreciated that the method 300 depicted in FIG. 8 is directed to operation of the electronic control unit 128 itself.

As noted above, it should be understood that there is a particular pressure ratio range between the pressure of the second gas flowing over the exterior surface 108 of the test component 102 and the pressure of the first gas flowing out of the seed holes 112 that should be utilized to provide optimal impact on the PSP coating of the test component 102. Therefore, prior to the electronic control unit 128 triggering the first gas source 104 and the second gas source 106, a seed flow pressure ratio is determined at step 302. As discussed in step 206 (FIG. 7), the seed flow pressure ratio is a ratio of the first gas flowing out of the seed holes 112 relative to the second gas flowing over the exterior surface 108 of the test component 102. At step 302, the electronic control unit 128 adjusts the first gas source 104 and the second gas source 106 to set the particular seed flow pressure ratio. Specifically, the electronic control unit 128 may be controlled to trigger the first gas source 104 to select a particular pressure for the first gas. Thereafter, the electronic control unit 128 may be controlled to trigger the second gas source 106 to select an appropriate pressure for the second gas that satisfies the seed flow pressure ratio. Alternatively, the electronic control unit 128 may be controlled to trigger the second gas source 106 to select a particular pressure for the second gas. Thereafter, the electronic control unit 128 may be controlled to trigger the first gas source 104 to select an appropriate pressure for the first gas that satisfies the seed flow pressure ratio.

Thereafter, at step 302, the first gas source 104 and the second gas source 106 continues operating via the electronic control unit 128. As described herein, the cooling gas source may also be operated in response to receiving instruction from the electronic control unit 128.

At step 304, the imaging device 110 captures image data relating to the visible increase in the fluorescence on the PSP caused by the flow of the first gas across the exterior surface 108 of the test component 102.

At step 306, the image data captured by the imaging device 110 is transmitted to the electronic control unit 128 that processes the image data to identify a seed flow streak or path of the first gas upon exiting the seed holes 112.

At step 308, the electronic control unit 128 determines the degree of deviation of the flow path of the first gas relative to the imaginary line L extending parallel to the centerline C of the test component 102. As described herein, the imaging device 110 may collect similar image data for each flow path of the first gas exiting each seed hole 112. Accordingly, the electronic control unit 128 may determine a degree of deviation for each flow path of the first gas at each seed hole relative to a respective imaginary line extending parallel to the centerline C of the test component 102.

Thereafter, the method 300 proceeds in a manner similar to that discussed above at step 212 (FIG. 7). Specifically, the electronic control unit 128 determines, after a predetermined time of triggering the first gas source 104 and the second gas source 106 and performing the test, if the deviation is equal to or less than the predetermined threshold such that a streak condition is satisfied. If so, the electronic control unit ceases operation of the first gas source 104 and the second gas source 106, and the test is stopped. Alternatively, if the deviation exceeds the predetermined threshold, the electronic control unit 128 determines what action may be taken to account for these excessive deviations.

From the above, it is to be appreciated that defined herein is a system for detecting fluid flow across an exterior surface of a test component and methods of operation. The system includes a test component including one or more seed holes receiving a first gas and detecting a deviation of the first gas exiting the seed holes due to a flow of a second gas passing over the seed holes. The deviation is detected by an imaging device, which transmits image data to an electronic control unit configured to determine whether the deviation exceeds a predetermined threshold. Thereafter, changes to one or more parameters may be made to the test component to ensure that the deviation of the first gas in subsequently formed test components does not exceed the predetermined threshold. This system and method for determining fluid flow across a surface of an object improves upon prior methods. Such prior methods include tuft testing, in which small strings or tufts are attached to a surface of an object and their movement with airflow is observed, anemometry, in which a fine wire is heated by an electrical current, placed in the airflow, and the cooling effect of the air determines a velocity, flow visualization with dye rather than pressure sensitive paint, and the like. However, these prior methods may provide limited qualitative and quantitative data, and may require careful calibration.

Further aspects of the embodiments described herein are provided by the subject matter of the following clauses:

A system for detecting fluid flow across a surface of a test component, the system comprising: a test component comprising: a first gas channel formed in the test component; an surface at least partially coated with pressure sensitive paint; and one or more seed channels formed in the test component extending from the first gas channel to the surface, the one or more seed channels extend from the surface of the test component at an angle greater than or equal to 70 degrees and less than or equal to 110 degrees relative to the surface, the one or more seed channels defining one or more seed holes formed in the surface opposite the first gas channel; a first gas source delivering a first gas to the first gas channel; a second gas source delivering a second gas across the one or more seed holes; an imaging device capturing image data of a seed flow streak of the first gas across the surface based on a change in luminescence intensity of the pressure sensitive paint; and an electronic control unit configured to: receive the image data from the imaging device; and determine whether an angle between the seed flow streak of the first gas exiting the one or more seed holes and an imaginary line extending from the respective seed hole parallel to a centerline of the test component is greater than a predetermined threshold.

The system of any of the preceding clauses, wherein a plurality of seed channels extend from the first gas channel to the surface of the test component, each of the plurality of seed channels defines an associated seed hole.

The system of any of the preceding clauses, wherein the one or more seed channels extend from the first gas channel at an angle greater than or equal to 70 degrees and less than or equal to 110 degrees relative to the surface.

The system of any of the preceding clauses, wherein the test component includes a porous material and the one or more seed channels extend through the porous material.

The system of any of the preceding clauses, wherein the test component further comprises: one or more cooling channels formed in the test component, the one or more cooling channels including a first cooling channel segment and a second cooling channel segment extending from the first cooling channel segment to the surface of the test component.

The system of any of the preceding clauses, wherein the second cooling channel segment extends from the first cooling channel segment at a cooling angle less than the angle at which the seed channel extends from the first gas channel.

The system of any of the preceding clauses, wherein the second cooling channel segment extends from the first cooling channel segment at a cooling angle greater than or equal to 15 degrees and less than or equal to 75 degrees relative to the surface.

The system of any of the preceding clauses, wherein the second cooling channel segment has a constant diameter.

The system of any of the preceding clauses, wherein a pressure ratio of the first gas relative to the second gas is greater than or equal to 1.01 and less than or equal to 1.2.

The system of any of the preceding clauses, wherein the electronic control unit is configured to determine one or more parameters of the test component to modify in response to determining that the angle between the seed flow streak and the imaginary line is greater than the predetermined threshold.

The system of any of the preceding clauses, wherein the electronic control unit is configured to cease operation of the first gas source and the second gas source in response to determining that the angle between the seed flow streak and the imaginary line is less than or equal to the predetermined threshold.

The system of any of the preceding clauses, wherein: a plurality of seed channels extend from the first gas channel to the surface of the test component, each of the plurality of seed channels defines an associated seed hole, the plurality of seed channels are equidistantly spaced apart from one another, and the plurality of seed channels are provided upstream of the one or more cooling channels.

A test component comprising: a first gas channel formed in the test component; a surface at least partially coated with pressure sensitive paint; and one or more seed channels formed in the test component extending from the first gas channel to the surface, the one or more seed channels defining one or more seed holes formed in the surface opposite the first gas channel, the one or more seed channels extending from the first gas channel at an angle of greater than or equal to 70 degrees and less than or equal to 110 degrees relative to the surface.

The test component of any of the preceding clauses, wherein a plurality of seed channels extend from the first gas channel to the surface of the test component, each of the plurality of seed channels defines an associated seed hole.

The test component of any of the preceding clauses, wherein the test component includes a porous material and the one or more seed channels extend through the porous material.

The test component of any of the preceding clauses, wherein: the test component further comprises: one or more cooling channels formed in the test component, the one or more cooling channels including a first cooling channel segment and a second cooling channel segment extending from the first cooling channel segment to the surface of the test component; and the second cooling channel segment extends from the first cooling channel segment at a cooling angle less than the angle at which the seed channel extends from the first gas channel.

The test component of any of the preceding clauses, wherein the second cooling channel segment extends from the first cooling channel segment at a cooling angle of greater than or equal to 15 degrees and less than or equal to 75 degrees relative to the surface.

The test component of any of the preceding clauses, wherein the second cooling channel segment has a constant diameter.

A method for detecting fluid flow across a surface of a test component, the method comprising: applying pressure sensitive paint to a test component, the test component comprising: a first gas channel formed in the test component; a surface at least partially coated with pressure sensitive paint; and one or more seed channels formed in the test component extending from the first gas channel to the surface, the one or more seed channels defining one or more seed holes formed in the surface opposite the first gas channel; triggering a first gas source to deliver a first gas into the test component and through the one or more seed holes; triggering a second gas source to deliver a second gas across the one or more seed holes; and determining whether an angle between a seed flow streak of the first gas exiting the one or more seed holes and an imaginary line extending from the respective seed hole parallel to a centerline of the test component is greater than a predetermined threshold.

The method of any of the preceding clauses, further comprising: capturing image data of the seed flow streak of the first gas across the surface based on a change in luminescence intensity of the pressure sensitive paint at least partially coating the surface of the test component.

The method of any of the preceding clauses, further comprising: selecting a seed flow pressure ratio, the seed flow pressure ratio of the first gas relative to the second gas being greater than or equal to 1.01 and less than or equal to 1.2.

The method of any of the preceding clauses, wherein in response to determining that the angle between the seed flow streak and the imaginary line is greater than the predetermined threshold, determining one or more parameters of the test component to modify.

A system of any one of the preceding clauses, comprising: an electronic control unit configured to: send a signal to an imaging device to capture image data; receive the image data from the imaging device; and determine whether an angle between a seed flow streak of a first gas exiting one or more seed holes and an imaginary line extending from the respective seed hole parallel to a centerline of a test component is greater than a predetermined threshold.

The system of any one of the preceding clauses, wherein the electronic control unit is further configured to set a pressure ratio of the first gas relative to a second gas to greater than or equal to 1.01 and less than or equal to 1.2.

The system of any one of the preceding clauses, wherein the electronic control unit is further configured to operate a first gas source to deliver the first gas into the test component and through the one or more seed holes.

The system of any one of the preceding clauses, wherein the electronic control unit is further configured to operate a second gas source to deliver a second gas across the one or more seed holes.

The system of any one of the preceding clauses, wherein the electronic control unit is further configured to send a signal to the image device to capture image data of the first gas across a surface based on a change in luminescence intensity of a pressure sensitive paint at least partially coating the surface of the test component.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A system for detecting fluid flow across a surface of a test component, the system comprising:
a test component comprising:
a first gas channel formed in the test component;
a surface at least partially coated with pressure sensitive paint; and
one or more seed channels formed in the test component extending from the first gas channel to the surface, the one or more seed channels extend from the surface of the test component at an angle greater than or equal to 70 degrees and less than or equal to 110 degrees relative to the surface, the one or more seed channels defining one or more seed holes formed in the surface opposite the first gas channel;
a first gas source delivering a first gas to the first gas channel;
a second gas source delivering a second gas across the one or more seed holes;
an imaging device capturing image data of a seed flow streak of the first gas across the surface based on a change in luminescence intensity of the pressure sensitive paint; and
an electronic control unit configured to:
receive the image data from the imaging device; and
determine whether an angle between the seed flow streak of the first gas exiting the one or more seed holes and an imaginary line extending from the respective seed hole parallel to a centerline of the test component is greater than a predetermined threshold.

2. The system of claim 1, wherein a plurality of seed channels extend from the first gas channel to the surface of the test component, each of the plurality of seed channels defines an associated seed hole.

3. The system of claim 1, wherein the one or more seed channels extend from the first gas channel at an angle of greater than or equal to 70 degrees and less than or equal to 110 degrees relative to the surface.

4. The system of claim 1, wherein the test component includes a porous material and the one or more seed channels extend through the porous material.

5. The system of claim 1, wherein the test component further comprises:
one or more cooling channels formed in the test component, the one or more cooling channels including a first cooling channel segment and a second cooling channel segment extending from the first cooling channel segment to the surface of the test component.

6. The system of claim 5, wherein the second cooling channel segment extends from the first cooling channel segment at a cooling angle less than the angle at which the seed channel extends from the first gas channel.

7. The system of claim 5, wherein the second cooling channel segment extends from the first cooling channel segment at a cooling angle of greater than or equal to 15 degrees and less than or equal to 75 degrees relative to the surface.

8. The system of claim 5, wherein the second cooling channel segment has a constant diameter.

9. The system of claim 1, wherein a pressure ratio of the first gas relative to the second gas is greater than or equal to 1.01 and less than or equal to 1.2.

10. The system of claim 1, wherein the electronic control unit is configured to determine one or more parameters of the test component to modify in response to determining that the angle between the seed flow streak and the imaginary line is greater than the predetermined threshold.

11. The system of claim 1, wherein the electronic control unit is configured to cease operation of the first gas source and the second gas source in response to determining that the angle between the seed flow streak and the imaginary line is less than or equal to the predetermined threshold.

12. The system of claim 5, wherein:
a plurality of seed channels extend from the first gas channel to the surface of the test component, each of the plurality of seed channels defines an associated seed hole, the plurality of seed channels are equidistantly spaced apart from one another, and
the plurality of seed channels are provided upstream of the one or more cooling channels.

13. A test component comprising:
a first gas channel formed in the test component;
a surface at least partially coated with pressure sensitive paint; and
one or more seed channels formed in the test component extending from the first gas channel to the surface, the one or more seed channels defining one or more seed holes formed in the surface opposite the first gas channel, the one or more seed channels extending from the first gas channel at an angle of greater than or equal to 70 degrees and less than or equal to 110 degrees relative to the surface.

14. The test component of claim 13, wherein a plurality of seed channels extend from the first gas channel to the surface of the test component, each of the plurality of seed channels defines an associated seed hole.

15. The test component of claim 13, wherein the test component includes a porous material and the one or more seed channels extend through the porous material.

16. The test component of claim 13, wherein:
the test component further comprises one or more cooling channels formed in the test component, the one or more cooling channels including a first cooling channel segment and a second cooling channel segment extending from the first cooling channel segment to the surface of the test component; and
the second cooling channel segment extends from the first cooling channel segment at a cooling angle less than the angle at which the seed channel extends from the first gas channel.

17. A method for detecting fluid flow across a surface of a test component, the method comprising:
applying pressure sensitive paint to a test component, the test component comprising:
a first gas channel formed in the test component;
a surface at least partially coated with pressure sensitive paint; and
one or more seed channels formed in the test component extending from the first gas channel to the surface, the one or more seed channels defining one or more seed holes formed in the surface opposite the first gas channel;
triggering a first gas source to deliver a first gas into the test component and through the one or more seed holes;
triggering a second gas source to deliver a second gas across the one or more seed holes; and
determining whether an angle between a seed flow streak of the first gas exiting the one or more seed holes and an imaginary line extending from the respective seed hole parallel to a centerline of the test component is greater than a predetermined threshold.

18. The method of claim 17, further comprising:
capturing image data of the seed flow streak of the first gas across the surface based on a change in luminescence intensity of the pressure sensitive paint at least partially coating the surface of the test component.

19. The method of claim 17, further comprising:
selecting a seed flow pressure ratio, the seed flow pressure ratio of the first gas relative to the second gas being greater than or equal to 1.01 and less than or equal to 1.2.

20. The method of claim 17, wherein in response to determining that the angle between the seed flow streak and the imaginary line is greater than the predetermined threshold, determining one or more parameters of the test component to modify.
